(19) United States
(12) Patent Application Publication
(10) Pub. No.: US 2006/0208995 A1
(43) Pub. Date: Sep. 21, 2006

(54) Liquid crystal display device

(75) Inventors: Akihiko Saitoh, Saitama-shi (JP); Katsunori Ookochi, Fukaya-shi (JP); Hiroyuki Kimura, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOSHIBA MATSUSHITA DISPLAY TECHNOLOGY CO., LTD., Minato-ku (JP)

(21) Appl. No.: 11/272,746

(22) Filed: Nov. 15, 2005

(30) Foreign Application Priority Data
Dec. 2, 2004 (JP) 2004-349794

(51) Int. Cl. G09G 3/36

(52) U.S. Cl. 345/100

(57) ABSTRACT

In order to facilitate connecting work of electrodes in a liquid crystal panel, a liquid crystal panel (2) includes: N pieces of electrodes connected to N pieces of electrodes in a first liquid crystal panel (1); NN (larger than N) pieces of signal lines connected to the N pieces of electrodes; and a signal line selecting circuit (22) which selects every N pieces from the NN pieces of signal lines in a time division manner, and connects the N pieces of signal lines to the N pieces of electrodes, in which N is equal to NN/n (where n is an integer of two or more). In such a way, as compared with the case of providing the electrodes for the signal lines of the second liquid crystal panel (2) correspondingly thereto, the number of electrodes can be reduced to 1/n.

### CROSS-REFERENCE TO RELATED APPLICATIONS

This application is based upon and claims the benefit of priority from Japanese Patent Application No. 2004-349794 filed on Dec. 2, 2004; the entire contents of which are incorporated herein by reference.

### BACKGROUND OF THE INVENTION

1. Field of the Invention

The present invention relates to a liquid crystal display device.

2. Description of the Related Art

In a cellular phone terminal of these days, a so-called folding liquid crystal display device in which a first liquid crystal panel and a second liquid crystal panel are connected to each other by a flexible print circuit (FPC) is used. The first liquid crystal panel displays, for example, a sentence of electronic mail, a picture image, and the like. The second liquid crystal panel displays a current time, a remaining amount of a battery, and the like. The number of signal lines of the second liquid crystal panel is smaller than the number of signal lines of the first liquid crystal panel.

Electrodes are disposed on terminal ends of the signal lines in the first liquid crystal panel, and electrodes are also disposed on tip ends of the signal lines in the second liquid crystal panel. The FPC is connected between the electrodes of the first liquid crystal panel and the electrodes of the second liquid crystal panel.

In the liquid crystal display device as described above, for example, when resolution of the second liquid crystal panel is increased so as to enable the display of the picture image and the like, the signal lines and electrodes thereof are increased in number, and an interval between the electrodes in the second liquid crystal panel is inevitably narrowed. Accordingly, it becomes difficult to connect the electrodes and the FPC to each other, which may lead to a reduction of yield in manufacturing the second liquid crystal panel.

### SUMMARY OF THE INVENTION

It is an object of the present invention to facilitate such connecting work of electrodes in a liquid crystal panel.

A first feature of a liquid crystal display device according to the present invention is in that the liquid crystal display device includes: a first liquid crystal panel including plural signal lines connectable to output nodes of a signal line drive circuit configured to output video signals, and N pieces of electrodes to which N pieces of the signal lines are connected; and a second liquid crystal panel including N pieces of electrodes connected to the electrodes, NN pieces of signal lines connectable to the N pieces of electrodes, NN being larger than N, and a signal line selecting circuit configured to select every N pieces from the NN pieces of signal lines in a time division manner, and to connect the N pieces of signal lines to the N pieces of electrodes, wherein N is equal to NN/n (where n is an integer of two or more).

In the first feature of the present invention, when every N pieces are selected from the NN pieces of signal lines in the time division manner in the second liquid crystal panel and are connected to the N pieces of electrodes, N is set equal to NN/n (where n is an integer of two or more). In such a way, as compared with the case of providing the electrodes for the signal lines of the second liquid crystal panel correspondingly thereto, the number of electrodes can be reduced to 1/n. In such a way, the electrode interval can be lengthened, and the connecting work of the electrodes in such a liquid crystal panel in which the number of signal lines is small is facilitated.

A second feature of the liquid crystal display device according to the present invention is in that the first liquid crystal panel includes: a signal line connecting circuit supplied with signal line selecting signals which select the signal lines during a period while the video signals are being written into the first liquid crystal panel and a period while the video signals are being written into the second liquid crystal panel, the signal line connecting circuit being configured to switch the signal lines in the time division manner and to connect the signal lines to output nodes of the signal line drive circuit during the periods; and a signal line selecting circuit supplied with the signal line selecting signals during the period while the video signals are being written into the first liquid crystal panel and the period while the video signals are being written into the second liquid crystal panel, the signal line selecting circuit being configured to select the N pieces of signal lines in the time division manner and to connect the N pieces of signal lines to the N pieces of electrodes during the periods, and the signal line selecting circuit of the second liquid crystal panel is supplied with the signal line selecting signals during the period while the video signals are being written into the first liquid crystal panel and the period while the video signals are being written into the second liquid crystal panel, and during the periods, selects the N pieces of signal lines in the time division manner, and connects the N pieces of signal lines to the N pieces of electrodes.

In the second feature of the present invention, the signal line connecting circuit which connects the signal lines to the output nodes also while the video signals are being written into the second liquid crystal panel is provided in the first liquid crystal panel. In addition, the signal line selecting circuit which selects the N pieces of signal lines in the time division manner and connects the N pieces of signal lines to the N pieces of electrodes while the video signals are being written into the second liquid crystal panel is provided in the second liquid crystal panel. In such a way, the video signals can be supplied to the second liquid crystal panel.

A third feature of the liquid crystal display device according to the present invention is in that the first liquid crystal panel is one in which the N pieces of signal lines and the N pieces of electrodes are connected to each other in advance, and includes: a signal line connecting circuit configured to select the signal lines in the time division manner and to connect the signal lines to the output nodes of the signal line drive circuit while signal line selecting signals which select the signal lines are being supplied thereto, and to keep on connecting the N pieces of signal lines to the output nodes of the signal line drive circuit while the signal line selecting signals are not being supplied thereto; and a control circuit configured to supply the signal line selecting signals to the signal line connecting circuit while the video signals are being written into the first liquid crystal panel, and to stop supplying the signal line selecting signals to the signal line connecting circuit while the video signals are being written into the second liquid crystal panel, the signal line selecting circuit of the second liquid crystal panel is one in which the signal lines are selected in the time division manner and connected to the electrodes while the signal line selecting signals are being supplied thereto, and the second liquid crystal panel includes: a control circuit configured to supply the signal line selecting signals to the signal line selecting circuit while the video signals are being written into the second liquid crystal panel, and to stop supplying the signal line selecting signals to the signal line selecting circuit while the video signals are being written into the first liquid crystal panel.

In the third feature of the present invention, the N pieces of signal lines and the N pieces of electrodes in the first liquid crystal panel are connected to each other in advance, and the N pieces of signal lines are kept on being connected to the N pieces of output nodes in the first liquid crystal panel while the video signals are being written into the second liquid crystal panel. In such a way, the video signals can be supplied to the second liquid crystal panel, and in addition, the number of signal line selecting circuits can be reduced.

A fourth feature of the liquid crystal display device according to the present invention is in that the first liquid crystal panel includes: red, green and blue pixels into which the video signals are written from the signal lines of the first liquid crystal panel, and the N pieces of signal lines kept on being connected to the output nodes of the signal line drive circuit are either of right and left signal lines adjacent to the blue pixels.

In the fourth feature of the present invention, for the signal lines kept on being connected to the output nodes, either of the right and left signal lines adjacent to the blue pixels is set. In such a way, image quality can be enhanced since an influence from potential fluctuations is less prone to be visually recognized in the blue pixels.

A fifth feature of the liquid crystal display device according to the present invention is in that, when the number of signal lines connectable to the output nodes is MM, and the number of signal lines connected to the output nodes is M, MM/M is equal to n.

In the fifth feature of the present invention, a ratio n of the number of signal lines and the number of connected signal lines is made common between the first liquid crystal panel and the second liquid crystal panel, thus making it possible to use the signal line selecting signals common between both of the liquid crystal panels. In such a way, an increase of the number of signal line selecting signals can be suppressed.

### BRIEF DESCRIPTION OF THE DRAWINGS

FIG. 1 is a plan view showing a schematic configuration of a liquid crystal display device of a first embodiment.

FIG. 2 is a circuit diagram of the liquid crystal display device of the first embodiment.

FIG. 3 is a timing chart showing an operation of the liquid crystal display device of FIG. 2.

FIG. 4 is a circuit diagram of a liquid crystal display device of a second embodiment.

### DESCRIPTION OF THE EMBODIMENT

### First Embodiment

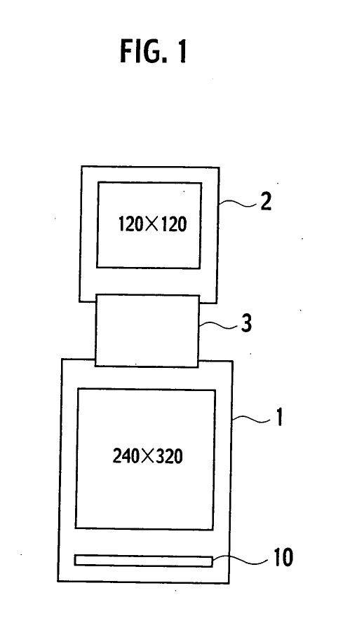

FIG. 1 is a plan view showing a configuration of a liquid crystal display device of this embodiment. As shown in this drawing, the liquid crystal display device is an active matrix type color liquid crystal display device which is made to be a folding type by connecting a first liquid crystal panel 1 and a second liquid crystal panel 2 to each other by an FPC 3. The first liquid crystal panel 1 is a panel of so-called QVGA with 320 rows and 240 columns. The second liquid crystal panel 2 has 120 rows and 120 columns. Each column includes three signal lines for red (R), blue (B), and green (G).

The first liquid crystal panel 1 with 320 rows and the second liquid crystal panel 2 with 120 rows are regarded as one liquid crystal panel with 440 rows, and a control is performed therefore, thus making it possible to reduce cost and time for developing a control sequence.

In the liquid crystal display device, a signal line drive circuit 10 which drives the signal lines provided in the first liquid crystal panel 1 is mounted on the first liquid crystal panel 1, for example, in a way of “Chip on Glass (COG)”. A scan line drive circuits which drive the scan lines are built into the first liquid crystal panel 1 and the second liquid crystal panel 2 respectively. Thus the scan line drive circuit need not be mounted on the first liquid crystal palnell in a way of COG.

Though not shown, each of the first and second liquid crystal panels 1 and 2 includes an array substrate, in which scan lines of which number is equivalent to the number of rows and signal lines of which number is three times the number of columns intersect with each other, and pixels are arranged on the respective intersections. Moreover, each of the pixels includes a switching element such as a thin film transistor which turns on when the scan line is driven, and a pixel electrode into which each video signal is written from the signal line through the switching element which has turned on.

In each liquid crystal panel, a liquid crystal layer is formed between the array substrate and an opposite substrate opposite thereto, and on each spot of the opposite substrate, which is opposite to each pixel electrode, a color layer of any of red, green, and blue is formed. In such a way, red, green and blue pixels are formed.

The signal lines, the scan lines, the switching elements, and the pixel electrodes in the first liquid crystal panel 1 and the second liquid crystal panel 2 are formed, for example, by a manufacturing process using polycrystalline silicon. In such a way, it is made possible to miniaturize each switching element and to enhance an aperture ratio of each pixel.

Moreover, the signal line drive circuit 10 can be formed in the first liquid crystal panel 1 integrally with the signal lines, scan lines, switching elements and pixel electrodes of the first liquid crystal panel 1. In such a way, the number of electrodes which connect the circuits to each other can be reduced.

Moreover, for example, at a position sandwiched by the first liquid crystal panel 1 and the second liquid crystal panel 2 when the liquid crystal display device is folded, a backlight device (not shown) is provided.

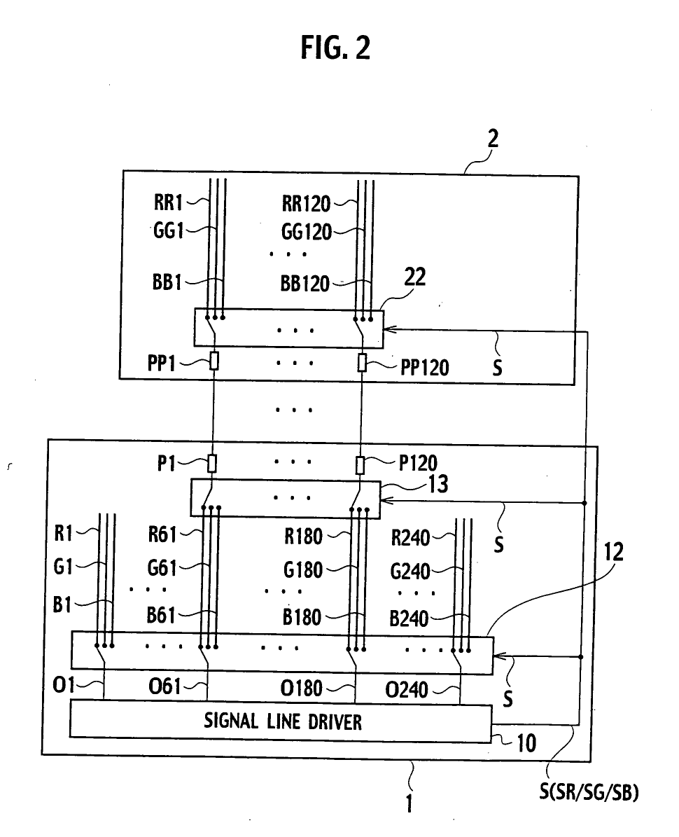

FIG. 2 is a circuit diagram of this liquid crystal display device. The signal line drive circuit 10 mounted on the first liquid crystal panel 1 outputs video signals for displaying video images on the first liquid crystal panel 1 and the second liquid crystal panel 2 from output nodes O1 . . . , O240, and outputs signal line selecting signals S for selecting the signal lines.

The signal line selecting signals S are composed of selecting signals SR, selecting signals SG, and selecting signals SB. The selecting signals SR indicate timing to select the respective signal lines (R1, R2 . . . ) which write video signals into the red (R) pixels. The selecting signals SG indicate timing to select the respective signal lines (G1, G2 . . . ) which write video signals into the green (G) pixels. The selecting signals SB indicate timing to select the respective signal lines (B1, B2 . . . ) which write video signals into the blue (B) pixels.

The first liquid crystal panel 1 includes the signal lines R1, G1, B1 . . . , R240, G240, B 240, and the signal line drive circuit 10 which drives the respective signal lines, a signal line connecting circuit 12, and a signal line selecting circuit 13. The signal line connecting circuit 12 selects signal lines from the signal lines R1, G1, B1 . . . , R240, G240, B240 at timing indicted by the respective selecting signals SR, SG and SB supplied thereto, and connects the selected signal lines to the respective output nodes of the signal line drive circuit 10. The signal line selecting circuit 13 selects signal lines from the signal lines R61, G61, B61 . . . , R180, G180, B180 at timing indicated by the respective selecting signals SR, SG and SB supplied thereto, and connects the selected signal lines to N (assumed to be equal to 120) pieces of electrodes P1 . . . , P120.

The signal line connecting circuit 12 and the signal line selecting circuit 13 are formed in the first liquid crystal panel 1 integrally with the signal lines, scan lines, switching elements, and pixel electrodes of the first liquid crystal panel 1, or with these circuits including the signal line drive circuit 10.

An interval (pixel interval) between the adjacent pixels in the first liquid crystal panel 1 is approximately 50 μm. Meanwhile, the electrodes P1 . . . , P120 are provided, for example, on extensions of the signal lines G61, G62 . . . , G180, and accordingly, an interval (electrode interval) between the adjacent electrodes is approximately 150 μm.

The second liquid crystal panel 2 includes N pieces of electrodes PP1 . . . , PP120 connected to the N pieces of electrodes P1 . . . , P120 of the first liquid crystal panel 1 through the FPC 3, NN (assumed to be equal to 360) pieces of signal lines RR1, GG1, BB1 . . . , RR120, GG120, BB120 selectively connected to the electrodes PP1 . . . , PP120, and a signal line selecting circuit 22. The signal line selecting circuit 22 selects signal lines from the signal lines RR1, GG1, BB1 . . . , RR120, GG120, BB120 at timing indicated by the respective selecting signals SR, SG and SB supplied thereto through the FPC 3, and connects the selected signal lines to the N pieces of electrodes PP1 . . . PP120.

The signal line selecting circuit 22 is formed in the second liquid crystal panel 2 integrally with the signal lines, scan lines, switching elements, and pixel electrodes of the second liquid crystal panel 2.

The pixel interval in the second liquid crystal panel 2 is approximately 50 μm. Meanwhile, the electrode interval, for example, when the electrodes PP1 . . . , PP120 are provided on extensions of the signal lines GG61, GG62 . . . , GG180, becomes approximately 150 μm.

[Operation while Video Signal is being Written into First Liquid Crystal Panel 1]

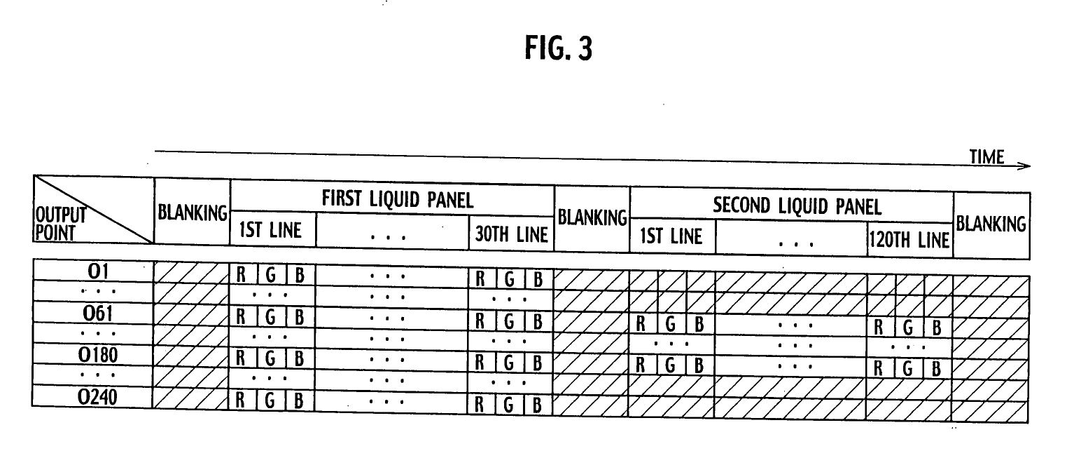

Next, a description is made of an operation of this liquid crystal display device by using a timing chart of FIG. 3. While the video signals are being written into the first liquid crystal panel 1 after a blanking period, the signal line drive circuit 10 supplies the signal line selecting signals S to the signal line connecting circuit 12 and signal line selecting circuit 13 of the first liquid crystal panel 1, and supplies the signal line selecting signals S to the signal line selecting circuit 22 of the second liquid crystal panel through the FPC 3.

During this period, first, the respective switching elements corresponding to the first row of the first liquid crystal panel 1 turn on. The signal line connecting circuit 12 in this ON period first selects the signal lines R1, R2 . . . , R240 at timing indicated by the selecting signals SR in the signal line selecting signals S, and connects these signal lines to the output nodes O1 . . . , O240 of the signal line drive circuit 10, respectively.

In such a way, the respective video signals are written into the red (R) pixels arranged on the respective intersections of the scan line of the first row and the signal lines R1, R2 . . . , R240. The respective pixels output red light having color reproducibility corresponding to voltages of the video signals in this case until the next write timing.

At this timing, the signal line selecting circuit 13 of the first liquid crystal panel selects the signal lines R61, R62 . . . , R180, and connects the signal lines R61, R62 . . . , R180 to the electrodes P1 . . . , P120 on the FPC 3 side, respectively.

Moreover, at this timing, the signal line selecting circuit 22 of the second liquid crystal panel selects the signal lines RR1, RR2 . . . , RR120, and connects the signal lines RR1, RR2 . . . , RR120 to the electrodes PP1 . . . , PP120 on the FPC 3 side, respectively.

During the ON period of the first row, the signal line connecting circuit 12 next selects the signal lines G1, G2 . . . , G240 at timing indicated by the selecting signals SG, and connects the signal lines G1, G2 . . . , G240 to the output nodes O1 . . . , O240 of the signal line drive circuit 10, respectively.

In such a way, the respective video signals are written into the green (G) pixels arranged on the respective intersections of the scan line of the first row and the signal lines G1, G2 . . . , G240. The respective pixels output green light having color reproducibility corresponding to voltages of the video signals in this case until the next write timing.

At this timing, the signal line selecting circuit 13 selects the signal lines G61, G62 . . . , G180, and connects the signal lines G61, G62 . . . , G180 to the electrodes P1 . . . , P120 on the FPC 3 side, respectively.

Moreover, at this timing, the signal line selecting circuit 22 selects the signal lines GG1, GG2 . . . , GG120, and connects the signal lines GG1, GG2 . . . , GG120 to the electrodes PP1 . . . , PP120 on the FPC 3 side, respectively.

During the ON period of the first row, the signal line connecting circuit 12 subsequently selects the signal lines B1, B2 . . . , B240 at timing indicated by the selecting signals SB, and connects the signal lines B1, B2 . . . , B240 to the output nodes O1 . . . , O240 of the signal line drive circuit 10, respectively.

In such a way, the respective video signals are written into the blue (B) pixels arranged on the respective intersections of the scan line of the first row and the signal lines B1, B2 . . . , B240. The respective pixels output blue light having color reproducibility corresponding to voltages of the video signals in this case until the next write timing.

At this timing, the signal line selecting circuit 13 selects the signal lines B61, B62 . . . , B180, and connects the signal lines B61, B62 . . . , B180 to the electrodes P1 . . . , P120 on the FPC 3 side, respectively.

Moreover, at this timing, the signal line selecting circuit 22 selects the signal lines BB1, BB2 . . . , BB120, and connects the signal lines BB1, BB2 . . . , BB120 to the electrodes PP1 . . . , PP120 on the FPC 3 side, respectively.

Similar operations to the above are sequentially performed from the second row to the 320-th row. In such a way, the video image is displayed on the first liquid crystal panel 1.

[Operation while Video Signal is being Written into Second Liquid Crystal Panel 2]

After the period while the video signals are being written into the first liquid crystal panel 1, the blanking period comes again, and thereafter, a period while the video signals are being written into the second liquid crystal panel 2 is started.

Also while the video signals are being written into the second liquid crystal panel, the signal line drive circuit 10 supplies the signal line selecting signals S to the signal line connecting circuit 12 and the signal line selecting circuit 13, and supplies the signal line selecting signals S to the signal line selecting circuit 22 through the FPC 3. At this time, the respective switching elements corresponding to the first row of the second liquid crystal panel 2 turn on.

The signal line connecting circuit 12 in this ON period first selects the signal lines R1, R2 . . . , R240 at timing indicated by the selecting signals SR, and connects these signal lines to the output nodes O1 . . . , O240 of the signal line drive circuit 10, respectively.

At this timing, the signal line selecting circuit 13 selects the signal lines R61, R62 . . . , R180, and connects the signal lines R61, R62 . . . , R180 to the electrodes P1 . . . , P120 on the FPC 3 side, respectively.

Moreover, at this timing, the signal line selecting circuit 22 selects the signal lines RR1, RR2 . . . , RR120, and connects the signal lines RR1, RR2 . . . , RR120 to the electrodes PP1 . . . , PP120 on the FPC 3 side, respectively.

In such a way, the respective video signals are written into the red (R) pixels arranged on the respective intersections of the scan line of the first row of the second liquid crystal panel 2 and the signal lines RR1, RR2 . . . , RR120. The respective pixels output red light having color reproducibility corresponding to voltages of the video signals in this case until the next write timing.

During the ON period of the first row of the second liquid crystal panel 2, the signal line connecting circuit 12 next selects the signal lines G1, G2 . . . , G240 at timing indicated by the selecting signals SG, and connects the signal lines G1, G2 . . . , G240 to the output nodes O1 . . . , O240 of the signal line drive circuit 10, respectively.

At this timing, the signal line selecting circuit 13 selects the signal lines G61, G62 . . . , G180, and connects the signal lines G61, G62 . . . , G180 to the electrodes P1 . . . , P120 on the FPC 3 side, respectively.

Moreover, at this timing, the signal line selecting circuit 22 selects the signal lines GG1, GG2 . . . , GG120, and connects the signal lines GG1, GG2 . . . , GG120 to the electrodes PP1 . . . , PP120 on the FPC 3 side, respectively.

In such a way, the respective video signals are written into the green (G) pixels arranged on the respective intersections of the scan line of the first row of the second liquid crystal panel 2 and the signal lines GG1, GG2 . . . , GG120. The respective pixels output green light having color reproducibility corresponding to amplitudes of the video signals in this case until the next write timing.

During the ON period of the first row of the second liquid crystal panel 2, the signal line connecting circuit 12 subsequently selects the signal lines B1, B2 . . . , B240 at timing indicated by the selecting signals SB, and connects the signal lines B1, B2 . . . , B240 to the output nodes O1 . . . , O240 of the signal line drive circuit 10, respectively.

At this timing, the signal line selecting circuit 13 selects the signal lines B61, B62 . . . , B180, and connects the signal lines B61, B62 . . . , B180 to the electrodes P1 . . . , P120 on the FPC 3 side, respectively.

Moreover, at this timing, the signal line selecting circuit 22 selects the signal lines BB1, BB2 . . . , BB120, and connects the signal lines BB1, BB2 . . . , BB120 to the electrodes PP1 . . . , PP120 on the FPC 3 side, respectively.

In such a way, the respective video signals are written into the blue (B) pixels arranged on the respective intersections of the scan line of the first row of the second liquid crystal panel 2 and the signal lines BB1, BB2 . . . , BB120. The respective pixels output blue light having color reproducibility corresponding to amplitudes of the video signals in this case until the next write timing.

Similar operations to the above are sequentially performed from the second row to the 120-th row. In such a way, the video image is displayed on the second liquid crystal panel 2.

As described above, the liquid crystal display device of this embodiment includes the first liquid crystal panel 1 having the N pieces of electrodes, and includes the second liquid crystal panel 2 having the N pieces of electrodes, the NN (larger than N) pieces of signal lines connected to the N pieces of electrodes, and the signal line selecting circuit 22 which selects every N pieces from the NN pieces of signal lines in a time division manner and connects the N pieces of signal lines to the N pieces of electrodes concerned, in which N is equal to NN/n (where n is an integer of two or more). In such a way, as compared with the case of providing the electrodes for the signal lines of the second liquid crystal panel 2 correspondingly thereto, the number of electrodes can be reduced to 1/n, and the electrode interval can be lengthened. Accordingly, connecting work of the electrodes of the second liquid crystal panel 2 to the FPC 3 is facilitated.

In particular, in the liquid crystal display device of FIG. 2, the first liquid crystal panel 1 includes the signal line connecting circuit 12, and the signal line selecting circuit 13. To the signal line connecting circuit 12, the signal line selecting signals S are supplied also while the video signals are written into the second liquid crystal panel 2, and during the period concerned, the signal line connecting circuit 12 selects the signal lines in the time division manner, and connects the signal lines to the output nodes of the signal line drive circuit 10. During the period concerned, the signal line selecting circuit 13 selects the N pieces of signal lines in the time division manner, and connects the N pieces of signal lines to the N pieces of electrodes. The second liquid crystal panel 2 includes the signal line selecting circuit 22 which is supplied with the signal line selecting signals S during both of the above-described periods, and selects the N pieces of signal lines in the time division manner and connects the N pieces of signal lines to the N pieces of electrodes during the periods concerned. In such a way, in the first liquid crystal panel 1, the signal lines are connected to the output nodes also while the video signals are being written into the second liquid crystal panel 2, and further, the N pieces of signal lines are selected in the time division manner, and are connected to the N pieces of electrodes. Accordingly, the video signals can be supplied to the second liquid crystal panel 2.

Moreover, it is assumed that the number of signal lines connectable to the output nodes of the signal line drive circuit 10 is MM, and that the number of signal lines connected thereto is M. Then, for example, since MM is equal to 720 and M is equal to 240 as shown in FIG. 2, MM/M becomes equal to 3. Specifically, MM/M and NN/N become equal to n. Accordingly, the signal line selecting signals S can be shared by the signal line connecting circuit 12 and the signal line selecting circuit 22. In such a way, the number of signal line selecting signals S can be prevented from being increased. Moreover, the number of output nodes of the signal line drive circuit 10 can be reduced, and a degree of freedom in designing wiring for the signal line selecting signals S can be enhanced.

### Second Embodiment

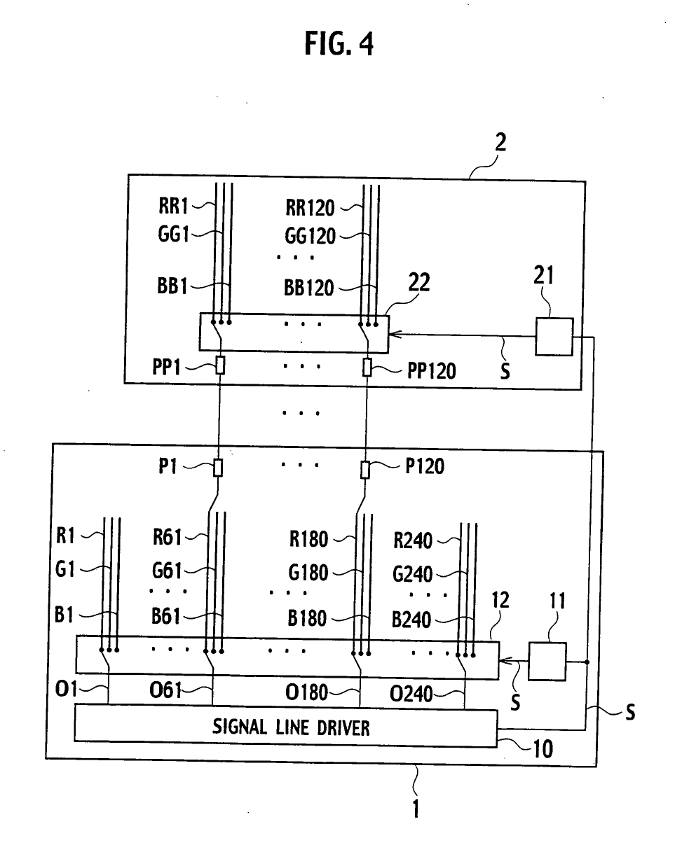

FIG. 4 is a circuit diagram of a liquid crystal display device in a second embodiment. A schematic configuration of this liquid crystal display device is similar to that in FIG. 1. Moreover, since a basic configuration of this circuit is similar to that in FIG. 2, the same reference numerals are assigned to the same constituent elements as those in FIG. 2, and a duplicate description is omitted. Differences between FIG. 2 and FIG. 4 are mainly described below.

As shown in FIG. 4, the liquid crystal panel 1 does not include the signal line selecting circuit 13, and instead of this, the signal lines R61, R62 . . . , R180 and the N pieces of electrodes P1 . . . , P120 are fixedly connected to each other in advance.

Moreover, the first liquid crystal panel 1 includes a control circuit 11. The control circuit 11 supplies, to the signal line connecting circuit 12, the signal line selecting signals S from the signal line drive circuit 10 while the video signals are being written into the first liquid crystal panel 1, and stops supplying the signal line selecting signals S to the signal line connecting circuit 12 while the video signals are being written into the second liquid crystal panel 2.

The second liquid crystal panel 2 also includes a control circuit 21. The control circuit 21 supplies the signal line selecting signals S to the signal line selecting circuit 22 while the video signals are being written into the second liquid crystal panel 2, and stops supplying the signal line selecting signals S to the signal line selecting circuit 22 while the video signals are being written into the first liquid crystal panel 1.

[Operation while Video Signal is being Written into First Liquid Crystal Panel 1]

While the video signals are being written into the first liquid crystal panel 1 after the blanking period in FIG. 3, the control circuit 11 of the first liquid crystal panel 1 supplies the signal line selecting signals S to the signal line connecting circuit 12, and the control circuit 21 of the second liquid crystal panel 2 stops supplying the signal line selecting signals S to the signal line selecting circuit 22.

During this period, first, the respective switching elements corresponding to the first row of the first liquid crystal panel 1 turn on.

During this ON period, the signal line connecting circuit 12 first selects the signal lines R1, R2 . . . , R240 at the timing indicated by the selecting signals SR in the signal line selecting signals S, and connects the signal lines R1, R2 . . . , R240 to the output nodes O1 . . . , O240 of the signal line drive circuit 10, respectively.

In such a way, the respective video signals are written into the red (R) pixels arranged on the respective intersections of the scan line of the first row and the signal lines R1, R2 . . . , R240. The respective pixels output red light having color reproducibility corresponding to voltages of the video signals in this case until the next write timing.

Note that the signal line selecting circuit 22 to which the selecting signals SR are not supplied, for example, keeps on connecting the signal lines BB1, BB2 . . . , BB120 selected last time to the electrodes PP1 . . . , PP120 on the FPC 3 side.

During the same ON period, the signal line connecting circuit 12 next selects the signal lines G1, G2 . . . , G240 at the timing indicated by the selecting signals SG, and connects the signal lines G1, G2 . . . , G240 to the output nodes O1 . . . , O240 of the signal line drive circuit 10, respectively.

In such a way, the respective video signals are written into the green (G) pixels arranged on the respective intersections of the scan line of the first row and the signal lines G1, G2 . . . , G240. The respective pixels output green light having color reproducibility corresponding to voltages of the video signals in this case until the next write timing.

Note that the signal line selecting circuit 22 to which the selecting signals SG are not supplied, for example, keeps on connecting the signal lines BB1, BB2 . . . , BB120 selected last time to the electrodes PP1 . . . , PP120 on the FPC 3 side.

During the same ON period, the signal line connecting circuit 12 subsequently selects the signal lines B1, B2 . . . , B240 at the timing indicated by the selecting signals SB, and connects the signal lines B1, B2 . . . , B240 to the output nodes O1 . . . , O240 of the signal line drive circuit 10, respectively.

In such a way, the respective video signals are written into the blue (B) pixels arranged on the respective intersections of the scan line of the first row and the signal lines B1, B2 . . . , B240. The respective pixels output blue light having color reproducibility corresponding to voltages of the video signals in this case until the next write timing.

Note that the signal line selecting circuit 22 to which the selecting signals SB are not supplied, for example, keeps on connecting the signal lines BB1, BB2 . . . , BB120 selected last time to the electrodes PP1 . . . , PP120 on the FPC 3 side.

Similar operations to the above are sequentially performed from the second row to the 320-th row. In such a way, the video image is displayed on the first liquid crystal panel 1.

[Operation while Video Signal is being Written into Second Liquid Crystal Panel 2]

Then, the blanking period comes again, and during the following period while the video signals are being written into the second liquid crystal panel 2, the control circuit 11 of the first liquid crystal panel 1 stops supplying the signal line selecting signals S to the signal line connecting circuit 12, and the control circuit 21 of the second liquid crystal panel 2 supplies the signal line selecting signals S to the signal line selecting circuit 22.

During this period, first, the respective switching elements corresponding to the first row of the second liquid crystal panel 2 turn on.

In this ON period, the signal line connecting circuit 12 selects the signal lines R1, R2 . . . , R240 connected to the N pieces of electrodes in advance, and connects the signal lines R1, R2 . . . , R240 to the output nodes O1 . . . , O240 of the signal line drive circuit 10.

Moreover, the signal line selecting circuit 22 selects the signal lines RR1 . . . , RR120 at the timing indicated by the selecting signals SR in this ON period, and connects the signal lines RR1 . . . , RR120 to the electrodes PP1 . . . , PP120 on the FPC side.

In such a way, the respective video signals are written into the red (R) pixels arranged on the respective intersections of the scan line of the first row of the second liquid crystal panel 2 and the signal lines RR1, RR2 . . . , RR120. The respective pixels output red light having color reproducibility corresponding to voltages of the video signals in this case until the next write timing.

During the same ON period, the signal line connecting circuit 12 maintains the state where the signal lines R1, R2 . . . , R240 are connected to the output nodes O1 . . . , O240 of the signal line drive circuit 10, respectively, even if the timing indicated by the selecting signals SG comes.

Meanwhile, the signal line selecting circuit 22 selects the signal lines GG1, GG2 . . . , GG120 at the timing indicated by the selecting signals SG, and connects the signal lines GG1, GG2 . . . , GG120 to the electrodes PP1 . . . , PP120 on the FPC 3 side, respectively.

In such a way, the respective vide signals are written into the green (G) pixels arranged on the respective intersections of the scan line of the first row of the second liquid crystal panel 2 and the signal lines GG1, GG2 . . . , GG120. The respective pixels output green light having color reproducibility corresponding to voltages of the video signals in this case until the next write timing.

During the same ON period, the signal line connecting circuit 12 maintains the state where the signal lines R1, R2 . . . , R240 are connected to the output nodes O1 . . . , O240 of the signal line drive circuit 10, respectively, even if the timing indicated by the selecting signals SB comes.

Meanwhile, the signal line selecting circuit 22 selects the signal lines BB1, BB2 . . . , BB120 at the timing indicated by the selecting signals SB, and connects the signal lines BB1, BB2 . . . , BB120 to the electrodes PP1 . . . , PP120 on the FPC 3 side, respectively.

In such a way, the respective video signals are written into the blue (B) pixels arranged on the respective intersections of the scan line of the first row of the second liquid crystal panel 2 and the signal lines BB1, BB2 . . . , BB120. The respective pixels output blue light having color reproducibility corresponding to voltages of the video signals in this case until the next write timing.

Similar operations to the above are sequentially performed from the second row to the 120-th row. In such a way, the image is displayed on the second liquid crystal panel 2.

As described above, in the liquid crystal display device of this embodiment, the first liquid crystal panel 1 includes the N pieces of signal lines and the N pieces of electrodes, which are connected to each other in advance, and further includes the signal line connecting circuit 12, and the control circuit 11. The signal line connecting circuit 12 selects the signal lines in the time division manner and connects the signal lines to the output nodes of the signal line drive circuit 10 while the signal line selecting signals S are being supplied thereto. Moreover, the signal line connecting circuit 12 keeps on connecting the N pieces of signal lines to the output nodes of the signal line drive circuit 10 while the signal line selecting signals S are not being supplied thereto. The control circuit 11 supplies the signal line selecting signals S to the signal line connecting circuit 12 while the video signals are being written into the first liquid crystal panel 1. Meanwhile, the control circuit 11 stops supplying the signal line selecting signals S to the signal line connecting circuit 12 while the video signals are being written in to the second liquid crystal panel 2. Moreover, the second liquid crystal panel 2 includes the signal line selecting circuit 22 which selects the signal lines in the time division manner and connects the signal lines to the electrodes while the signal line selecting signals S are being supplied thereto, and further includes the control circuit 21. The control circuit 21 supplies the signal line selecting signals S to the signal line selecting circuit 22 while the video signals are being written into the second liquid crystal panel 2. Meanwhile, the control circuit 21 stops supplying the signal line selecting signals S to the signal line selecting circuit 22 while the video signals are being written into the first liquid crystal panel 1.

Specifically, the N pieces of signal lines and the N pieces of electrodes in the first liquid crystal panel 1 are connected to each other in advance, and while the video signals are written into the second liquid crystal panel 2, the N pieces of signal lines are kept on being connected to the N pieces of output nodes in the liquid crystal panel 1. In such a way, the video signals can be supplied to the second liquid crystal panel, and in addition, the number of signal line selecting circuits can be reduced.

Note that, like the first liquid crystal panel 1 of FIG. 4, when the N pieces of signal lines are kept on being connected to the N pieces of output nodes while the video signals are being written into the second liquid crystal panel 2, the first liquid crystal panel 1 has possibilities that, owing to parasitic capacitance between the signal lines and the pixels adjacent to the signal lines concerned, potentials of the pixels concerned will be fluctuated, and that an influence thereof will be visually recognized unexpectedly.

In this connection, since potential fluctuations of the blue pixels are less prone to be visually recognized, it is preferable that the signal lines kept on being connected to the output nodes be either of right and left signal lines adjacent to the blue pixels. Specifically, either of the signal lines which write the video signals into the blue pixels and the signal lines which are adjacent to the pixels concerned though do not write the video signals into the blue pixels should be the signal lines kept on being connected to the output nodes. In such a way, a deterioration of image quality owing to the influence from the potential fluctuations of the pixels can be suppressed.

Note that, though N is set equal to 120 in the respective embodiments described above, N can be increased or reduced according to the number of columns of the second liquid crystal panel 2.

Moreover, the electrodes P1 . . . , P120 may also be connected to signal lines located at positions entirely shifted to the left or the right from the signal lines connected to the electrodes concerned in FIG. 2. Moreover, such connection as thinning these signal lines may also be made.

Moreover, in the respective embodiments as described above, the video image is adapted to be displayed by the red (R), green (G) and blue (B) pixels. However, in the case of displaying the image by pixels of two colors or four colors or more, a configuration corresponding to the number of colors just needs to be adopted.

What is claimed is:

1. A liquid crystal display device, comprising:
a first liquid crystal panel including plural signal lines connectable to output nodes of a signal line drive circuit configured to output video signals, and N pieces of electrodes to which N pieces of the signal lines are connected; and
a second liquid crystal panel including N pieces of electrodes connected to the electrodes, NN pieces of signal lines connectable to the N pieces of electrodes, NN being larger than N, and a signal line selecting circuit configured to select every N pieces from the NN pieces of signal lines in a time division manner, and to connect the N pieces of signal lines to the N pieces of electrodes,
wherein N is equal to NN/n (where n is an integer of two or more).

2. The liquid crystal display device according to claim 1,
wherein the first liquid crystal panel includes:
a signal line connecting circuit supplied with signal line selecting signals which select the signal lines during a period while the video signals are being written into the first liquid crystal panel and a period while the video signals are being written into the second liquid crystal panel, the signal line connecting circuit being configured to switch the signal lines in the time division manner and to connect the signal lines to output nodes of the signal line drive circuit during the periods; and
a signal line selecting circuit supplied with the signal line selecting signals during the period while the video signals are being written into the first liquid crystal panel and the period while the video signals are being written into the second liquid crystal panel, the signal line selecting circuit being configured to select the N pieces of signal lines in the time division manner and to connect the N pieces of signal lines to the N pieces of electrodes during the periods, and
the signal line selecting circuit of the second liquid crystal panel is supplied with the signal line selecting signals during the period while the video signals are being written into the first liquid crystal panel and the period while the video signals are being written into the second liquid crystal panel, and during the periods, selects the N pieces of signal lines in the time division manner, and connects the N pieces of signal lines to the N pieces of electrodes.

3. The liquid crystal display device according to claim 1,
wherein the first liquid crystal panel is one in which the N pieces of signal lines and the N pieces of electrodes are connected to each other in advance, and includes:
a signal line connecting circuit configured to select the signal lines in the time division manner and to connect the signal lines to the output nodes of the signal line drive circuit while signal line selecting signals which select the signal lines are being supplied thereto, and to keep on connecting the N pieces of signal lines to the output nodes of the signal line drive circuit while the signal line selecting signals are not being supplied thereto; and
a control circuit configured to supply the signal line selecting signals to the signal line connecting circuit while the video signals are being written into the first liquid crystal panel, and to stop supplying the signal line selecting signals to the signal line connecting circuit while the video signals are being written into the second liquid crystal panel,
the signal line selecting circuit of the second liquid crystal panel is one in which the signal lines are selected in the time division manner and connected to the electrodes while the signal line selecting signals are being supplied thereto, and
the second liquid crystal panel includes:
a control circuit configured to supply the signal line selecting signals to the signal line selecting circuit while the video signals are being written into the second liquid crystal panel, and to stop supplying the signal line selecting signals to the signal line selecting circuit while the video signals are being written into the first liquid crystal panel.

4. The liquid crystal display device according to claim 3,
wherein the first liquid crystal panel includes:
red, green and blue pixels into which the video signals are written from the signal lines of the first liquid crystal panel, and
the N pieces of signal lines kept on being connected to the output nodes of the signal line drive circuit are either of right and left signal lines adjacent to the blue pixels.

5. The liquid crystal display device according to claim 1,
wherein, when the number of signal lines connectable to the output nodes is MM, and the number of signal lines connected to the output nodes is M, MM/M is equal to n.
